(19) United States
(12) Patent Application Publication
(10) Pub. No.: US 2010/0065302 A1
(43) Pub. Date: Mar. 18, 2010

(54) ELECTRICAL CONNECTOR WITH PRESSURE SEAL

(75) Inventor: Richard Nesbitt, North Yorkshire (GB)

Correspondence Address: WOLF GREENFIELD & SACKS, P.C., 600 ATLANTIC AVENUE, BOSTON, MA, 02210-2206, US

(73) Assignee: Romote Marine Systems Limited, Malton, North Yorkshire (GB)

(21) Appl. No.: 12/312,006

(22) PCT Filed: Oct. 25, 2007
(86) PCT No.: PCT/GB2007/004072

§ 371 Date: Nov. 25, 2009

(30) Foreign Application Priority Data
Oct. 26, 2006 (GB) 0612333.4

(51) Int. Cl. H01B 7/00; H01R 43/00

(52) U.S. Cl. 174/116; 29/825

(57) ABSTRACT

A connector 1 for facilitating a pressure-tight electrical connection through a well head comprises a hollow body 2 having upper and lower openings 3, 4, a bulkhead 12 provided in the body 2 and a conductor 18 removably held in the bulkhead 12 by a retaining plate 26. A portion of the conductor protrudes from the bulkhead 12 in the direction of the lower opening 4. The conductor 18 has an insulating layer 20 insulating the conductor from the bulkhead 12 and extending along part of the said protruding portion, forming a pressure barrier between the first and second openings 3, 4. Cable strands 34 are crimped to the pins 16 and the joins insulated by tape 40, 42. This construction allows one to fit the cable 30 to the pins before finally sealing the connector in place, which speeds up installation.

The present invention relates to a connector for facilitating an electrical connection through a pressure barrier.

When extracting oil from an oil well, if the pressure of the oil is not sufficient to bring it to the surface, it is necessary to use an artificial lift to drive it to the surface. One type of artificial lift is known as an electrical submersible pump (ESP). A well bore is surrounded by a metal casing for support and has radial openings in the bottom to allow the oil to enter the bore. A pump and a motor are submerged in the oil and are connected to a production tube and a three-phase power supply. Above the motor and pump is a cylindrical cap or plug known as a packer that has approximately the same cross-section as the internal cross-section of the casing. The packer forms a seal that keeps the oil below it. In order to prevent the packer from moving, a head of fluid is provided on top of it. The fluid may contain, for example, a combination of crude oil, brine, high-pressure carbon dioxide and hydrogen sulphide. This fluid is pressurised, and to contain it within the well hole a cap is placed at the top of the well bore. This cap is known as the wellhead and, like the packer, it forms a seal that keeps fluid below it.

The wellhead comprises a lower part to which the production tubing is attached, known as the tubing hanger, and an upper part known as the tubing head adapter or “bonnet”. The production tube that is connected to the pump must penetrate both the packer and the wellhead in order to bring the oil to the surface. A cable supplying three-phase power to the motor and pump must also penetrate the packer and the wellhead. This is done by sealing either three individual electrical connectors or a single multi-core electrical connector in both the packer and the wellhead. These connectors are known as packer penetrators and wellhead penetrators respectively. The connectors must accommodate electrical connections and must be pressure-tight, watertight and resistant to corrosion.

A wellhead penetrator is typically a three-pin male connector and is usually supplied with a length of cable attached, known as a pigtail. Before use, the pigtail is spliced, using a standard field splice, onto a longer length of cable which extends down the well and is attached to the packer penetrator. The wellhead penetrator is fixed into the wellhead. Power is supplied to the connector by attachment of a three-pin female connector.

The splice is formed in the following manner. The individual cores of both the pigtail and the main cable run are separated and a portion of insulation is removed from each. Corresponding cores of the pigtail and main cable run are then crimped together using a crimp connection of approximately the same diameter as the diameter of the core insulation. Several wraps of dielectric tape are then applied over each crimp connection so that it overlaps with the insulation of both the pigtail and main cable core. Several wraps of a high-modulus tape are then applied over each dielectric layer to form a chemical barrier. Finally, a number of wraps of glass-fibre tape are applied over each chemical barrier layer. This adds mechanical strength to the previously formed layers. The tape wraps are applied under tension in order to provide a tightly packed assembly which keeps the well fluids off the joint and resists decompression damage. The individual cores are then brought back together and strips of rubber cable jacketing are used to fill the gaps. A further layer of glass-fibre tape is formed over the group of cores and a layer of metal cable-armouring is wrapped around the assembly to provide support and protection.

A splice, as described above, is relatively simple to perform and has been proven to be extremely reliable. Conventionally, however, it is not possible to use a standard field splice in a penetrator connector body because of the lack of space and the difficulty in individually insulating the cores.

A known type of wellhead penetrator connector comprises three conductor pins moulded into a bulkhead that is located towards the top of a cylindrical body. Three cores of a length of multi-core cable are crimped onto the end of the pins located within the body. The cavity of the cylindrical body, within which the pins are located, is filled with an insulating compound that is subsequently vulcanised, forming a barrier. This barrier insulates the pins, prevents the pins from coming into contact with damaging well fluids and acts as a support block, supporting the cable within the lower end of the cylindrical body. Whilst this results in a reliable multi-core connector that is pressure-tight, watertight and resistant to well fluids it is extremely time-consuming and expensive to manufacture, requiring expensive plant.

Various insulating arrangements are shown for instance in GB 2420919 (Weatherford/Lamb Inc.) and GB 2338119 (Tronic), but they do not show splice-type joints.

According to one aspect of the invention there is provided a connector for an electrical connection through a pressure barrier as defined in claim 19.

Having the insulated conductor pins removable from the bulkhead allows one to perform a standard “splice”, i.e. a manual join, in the field, because they can be cut to length while in situ, removed from the bulkhead again, separated from each other, joined to respective cable cores and insulated with standard tape, and then re-inserted. Preferably the insulating layer of each pin is polyetheretherketone (PEEK), which has excellent mechanical and electrical properties.

The bulkhead is preferably of non-ferromagnetic metal and the conductor may be removable from the bulkhead in the direction of the second, i.e. the lower, opening. Further, the bulkhead may be removably held in the body, being seated on a shoulder within the body and held in place by a lock ring threaded to the hollow body. There may be a circumferential groove in the outer surface of the bulkhead with an O-ring located in it to seal against the interior of the hollow body.

Preferably the or each conductor is located in an axial opening in the bulkhead. There may be a circumferential groove in the outer surface of the insulating layer with an O-ring located in it, sealing against the bulkhead.

Furthermore, the diameter of the or each axial opening is preferably larger at the bottom of the bulkhead than at the top of the bulkhead, the diameter of each opening being tapered towards the top. There may be a bulge in the cross-section of the insulating layer of each conductor that is of substantially the same diameter as the diameter of the opening at the bottom of the bulkhead, the top of the bulge engaging with the tapered part of the opening. The bottom of the bulge may be tapered or chamfered, preferably at about 20-80°. A collar may be located around the lower end of the bulge, the upper end of the collar engaging with the chamfered part of the bulge.

The retaining means may be in the form of a plate or disc secured to the underside of the bulkhead, with apertures corresponding to the pin or pins.

Preferably there is an enlargement in the diameter of the conductor at the end of the portion extending below the bulkhead. The outer diameter of the enlargement may usefully be substantially the same as the outer diameter of the insulating layer. The end of the conductor portion protruding from the bulkhead may have an axial recess for receiving a cable conductor.

A second portion of the conductor may protrude above the bulkhead in the direction of the first opening and the insulating layer may cover a part of the second protruding conductor portion. A removable rubber boot may be fitted over the said second protruding conductor portion.

Preferably there is a radially extending opening in the body below the bulkhead for the injection of potting compound.

In a typical application there are a plurality of conductors in the bulkhead, for instance three conductors for three-phase current.

A connector assembly using the connector of the invention may further comprise: a length of cable located in the second opening having an insulated core, the core being connected to the conductor; an insulating layer surrounding the connection of the conductor and the core and overlapping the insulating layer of the conductor and the insulating layer of the core; a chemical barrier layer resistant to well-fluids on top of the insulating layer; and a potting compound filling the cavity between the bulkhead and the second opening.

Preferably the conductor and core are crimped together. The insulating layer may be a number of wraps of dielectric tape. The chemical barrier layer may be a number of wraps of chemical barrier tape. The potting compound may be an epoxy potting compound.

The invention also relates to a connector assembly including such a connector with a length of cable attached, the joint being insulated by tape, preferably fluoropolymer tape. The invention is also directed to a wellhead having a tubing hanger and a connector as described herein, penetrating the tubing hanger for supplying power to devices located down the well.

According to another aspect of the invention there is provided a connector assembly according to claim 1, with the conductor either being held in a removable bulkhead or being itself removable.

The invention also comprises a method of forming an electrical connection through a pressure barrier in a hollow body having a bulkhead, as defined in claim 10.

Preferably the method further includes the step of forming a chemical barrier layer, resistant to well fluids, over the insulating layer. The method may include the step of filling the cavity in the hollow body in which the joint is located with a potting compound. The cavity may be filled by injecting a potting compound through openings in the wall of the hollow body.

Preferably the method further includes the steps of removing the bulkhead from the hollow body before inserting the conductor into the bulkhead, and replacing the bulkhead in the hollow body after reinserting the conductor into the bulkhead. The conductor may be removed from and reinserted into the bulkhead from the lower side of the bulkhead.

The insulating layer may be formed by wrapping dielectric tape around the joint under tension. The chemical barrier layer may be formed by wrapping chemical barrier tape around the insulating layer under tension.

For a better understanding of the invention, an embodiment of it will now be described, by way of example only, with reference to the accompanying drawings, in which:

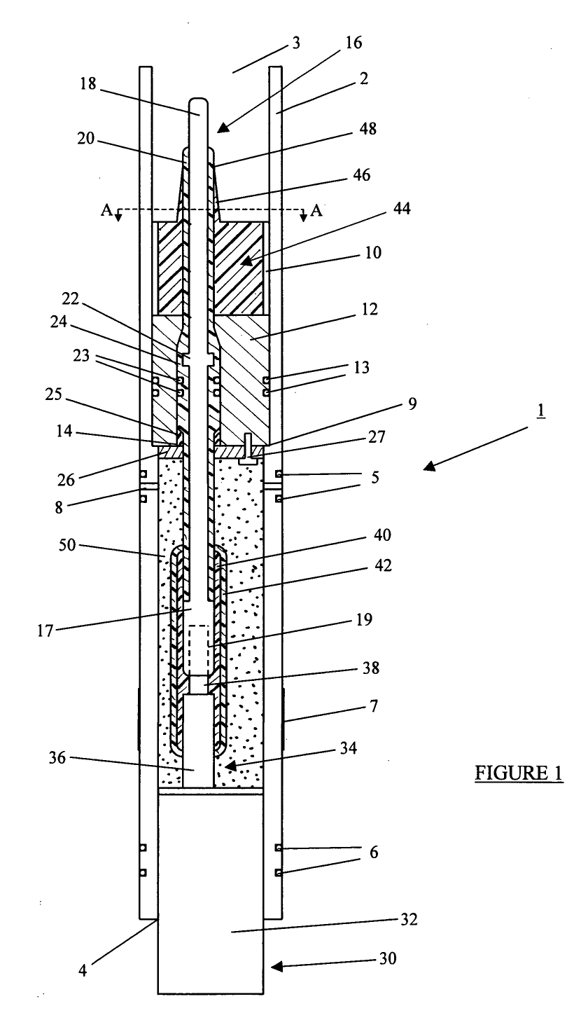

FIG. 1 shows a schematic axial cross-sectional view of a connector embodying the invention,

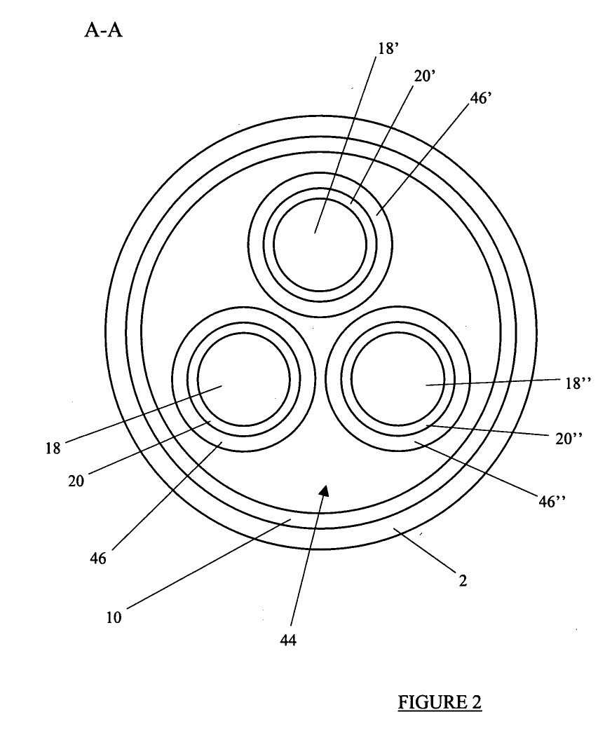

FIG. 2 shows a schematic cross-sectional view along the line A-A in FIG. 1, and

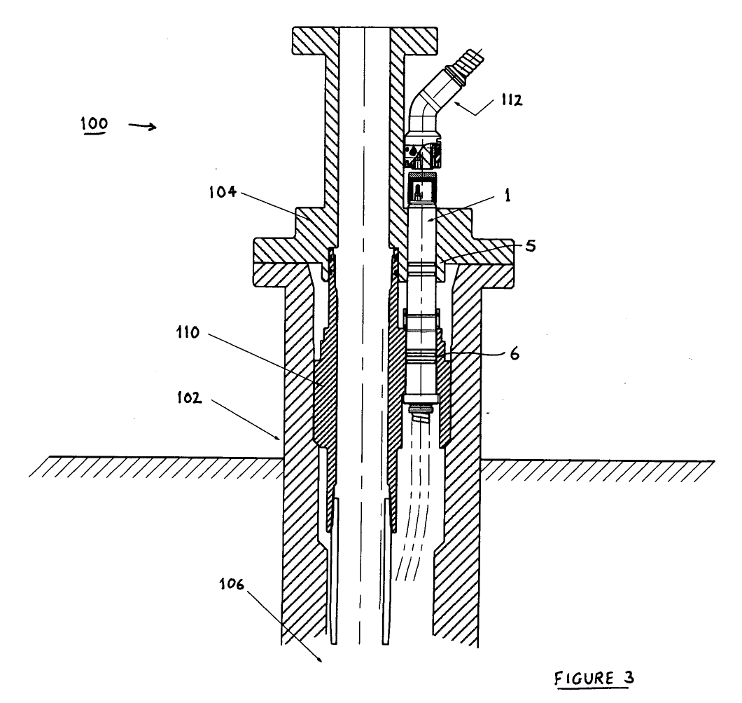

FIG. 3 shows the connector in place in a wellhead.

Referring to FIG. 1 and FIG. 2, the wellhead penetrator connector assembly 1 comprises a cylindrical hollow body 2 having first and second openings 3, 4 within which, towards the first opening 3, is held a cylindrical metal bulkhead 12. The bulkhead rests on a shoulder 9 within the body 2 and is secured in place using a lock ring 10 inside the body 2 on top of the bulkhead 12. It is sealed to the inside of the sleeve-shaped body 2 by O-rings 13.

Located below the shoulder 9 are two cylindrical grooves in the outer surface of the body 2 with O-ring seals 5 located in them. Located towards the second opening 4 are another two cylindrical grooves in the outer surface of the body with seals 6 located in them. In between the two upper grooves and seals 5 there are a number of radially extending openings 8 that pass through the wall of the body 2. The bulkhead 12 is made from a non-ferromagnetic stainless steel. The non-ferromagnetic nature of the bulkhead 12 reduces the extent to which the bulkhead heats up as a result of alternating magnetic fields caused by the alternating current passing through the pins.

The bulkhead 12 has three openings or passages 14 which each hold an insulated pin structure 16. Each pin 16 comprises a 6 mm-diameter rod-shaped copper conductor 18 having a gold-plated tip and is encased in a layer of polyetheretherketone (PEEK) 20 with a portion of the copper conductor being exposed at the top. The PEEK layer 20 forms a dielectric layer between the conductor and the bulkhead and forms a pressure barrier within the bulkhead. The lower end of each copper conductor 18 has an enlargement in cross-section 17 that is not coated by the PEEK layer 20 but is of the same diameter as the overall diameter of the adjacent part of the pin structure 16. The bottom of each copper conductor 18 has a cylindrical hollow cavity 19 that is open at the bottom. The axial length of the pins 16 is longer than that of the metal bulkhead 12 and a portion of each pin protrudes from either side of the bulkhead 12.

There is a bulge 22 in the cross-section of each copper conductor approximately halfway along the axial length, within the bulkhead. At this point there is also a bulge 24 in the PEEK layer 20. The openings 14 in the bulkhead 12 are thus not of a constant diameter: the openings 14 at the bottom of the bulkhead 12 are approximately the same as the diameter of the bulge of the pin (i.e. of the PEEK layer), while their diameter tapers off towards the top of the bulkhead 12 where it is approximately the same as the general pin diameter. Thus the pins 16 can be inserted into the openings 14 in the bulkhead 12 from the underside and are held in place by a retainer plate 26. Seals are formed by O-rings 23 between the PEEK layer and the bulkhead.

The lower end of the bulge 24 in the PEEK layer 20 is tapered at a point within the bulkhead and engage with a collar 25 that fits over the pin structure 16 and has its upper ends likewise tapered. When the pin 16 is located in the opening 14 and the collar 25 is engaged with the bulge 24 in the PEEK layer 14 the bottom of the collar 25 protrudes from the bottom of the bulkhead 12 by approximately 1 mm. The retainer plate 26, having a slotted or rounded opening for each pin 16, is fitted to the bottom of the bulkhead 12 using three screws 27 and holds the collars 25 and hence the pins 16 within the bulkhead 12. Having an angled contact area between the PEEK layer 20 and the collar 25 means that the pin 16 can withstand a larger force than would be possible with a 90° contact area.

A pressure barrier is formed between the first and second openings 3, 4 across the bulkhead 12. This is by virtue of the seals 13 between the bulkhead and the body 2 and the seals 23 between the PEEK layer 20 and the bulkhead.

The connector is usually supplied with a length of cable 30, which is attached to the connector 1 in the following way. An insulated pin 16 is inserted into each of the three openings 14 in the bulkhead 12 from the underside. A chamfered collar 25 is then slid over each pin 16 from the bottom and is pushed up into each opening 14 so as to engage with the chamfered end of the bulge 24 in the PEEK layer 20 of each pin 16. The pins 16 and collars 25 are then secured in place using the retainer plate 26. A length of cable 30 is prepared by cutting back the outer sheath 32 to expose three individually insulated cables 34. A length of the insulation 36 is then stripped from each of the three cables 34 to expose the copper core 38. Each copper core 38 is then inserted into the hollow cavity 19 in the bottom of a pin 16. The cores 38 are then crimped to the pins 16 by applying a large radial force to the bottom of each pin. Crimping the cable 30 to the pins 16 whilst they are held in place by the bulkhead 12 ensures that the cable cores 38 are of the correct length.

The pins 16, attached to the cable cores, are then removed from the bulkhead 12 and separated from each other. A fluoropolymer tape having a high dielectric strength is repeatedly spirally wrapped—generally 4-6 times, depending on the insulation requirement—over the crimp to form a dielectric layer 40. This tape extends as far up the pin as the PEEK layer 20 and as far down as the insulation 36 of the individual cables 36. The thickness of this layer is usually no more than about 4.5 mm, usually approximately 1 mm. A second fluoropolymer protective tape that is mechanically strong, waterproof and resistant to the corrosive well fluids is then wrapped over this dielectric layer 40 forming a protective layer 42. The thickness of this second layer is approximately 1 mm. The pins 16 are then slotted into the retainer plate 26 and returned to the openings 14 in the bulkhead 12, whereupon the retainer plate 26 is fixed to the bottom of the bulkhead 12. A further protective layer is formed over the individually protected pins 16 by wrapping all three pins with a further layer of tape. These layers of tape insulate the pins 18 from one another and prevent the individual copper cores from shorting. As opposed to using layers of tape for insulation and chemical resistance it would be possible to use heat-shrink layers. Further, it would be possible to use a single layer that both insulates the conductors and is chemically resistant.

The assembly is then inserted into the top of the hollow body 2 with the cable 30 inserted first. The bulkhead 12 is pushed down until it is seated on the shoulder 9 of the body 2 and the lock ring 10 is screwed down on top of the bulkhead so that it is firmly held in place. A single rubber boot 44 having three protrusions 46, 46′, 46″ each with an opening 48 is slid over the top of the three pins 16. The three openings 48 in the three protrusions 46 receive the three pins 16. The protrusions 46 are tapered and extend up the pins 16 to approximately the same level as the PEEK layer 20, leaving an exposed portion of the copper conductor 18.

The rubber boot 44 is particularly susceptible to damage. Since the rubber boot 44 is removable, however, it is possible to replace it should damage occur. The female connector for engagement with the male connector has tapered openings corresponding to position of the pins of the male connector. The openings are tapered towards the bottom and are of a slightly smaller diameter than the diameter of the protrusions 46 of the rubber boot 44. This means that when the female connector is engaged with the male connector the rubber protrusions 46 are compressed. This forms a tight seal and prevents water forming a current path between adjacent pins.

An epoxy potting compound 50 is injected into the cavity defined by the retainer plate 26 and the cable 30 through the radial openings 8 in the body 2. Once this cavity has been filled with the epoxy potting compound 50 the openings 8 are blocked off. The epoxy potting compound 50 keeps the majority of the well fluids off the pins and is both chemically and thermally resistant. High-pressure gas (for example carbon dioxide) will permeate through the epoxy potting compound and fill any cavities in the assembly. However, if there is a significant drop in pressure in the well then the epoxy potting compound ensures that the high-pressure gas discharges from the cavities slowly, thus avoiding an explosive decompression. The epoxy potting compound 50 supports the assembly in the same way as does the glass-fibre tape and the metal cable-armouring in a standard field splice. Modifying the standard field splice in this way makes it easier for it to fit within the tight space available in the wellhead penetrator connector. It would, however, be possible in principle to use a glass-fibre tape wrap instead of the epoxy. The thickness of such a glass-fibre tape wrap would generally be less than 3.5 mm.

In use the connector assembly is spliced onto a longer length of cable and the connector assembly can be fitted into a wellhead using a lock ring attached to the connector body 2 via the threaded portion 7. The two seals in the upper grooves 5 form a pressure seal with the wellhead bonnet and the two seals in the lower grooves 6 form a pressure seal with the tubing hanger.

FIG. 3 shows the penetrator connector assembly 1 in place in a wellhead 100. The wellhead consists of a casing 102 penetrating the ground or ocean floor and a bonnet 104 resting on the casing. The casing is a hollow tube the interior of which forms the downhole 106, into which a pipe extends for oil extraction. A wellhead hanger 110 fits the top of the pipe and connects to a tubular part on the bonnet.

The penetrator 1 extends down through the bonnet next to the pipe, and then on down through the wellhead hanger, being sealed respectively by the O-rings 5 and 6. An angled top connector 112 fits onto the protruding top of the hollow body of the connector, with sockets adapted to take the upper ends of the pins. A cable runs from the connector 1 down the downhole to supply a pump or other equipment.

Although an embodiment has been described in which there are three conductors, the present invention may be applied to a connector having any number of conductors. If the present invention is applied to a connector having a single conductor then it is not necessary for the pin 16 to be removable from the bulkhead 12. This is because it is possible to insulate the joint with the pin still in the bulkhead.

For supplying three-phase power to a device down a well hole it may be desirable to use three connectors of the type envisaged by the present invention, each having a single conductor 18, for each core of a three-phase cable, as opposed to a single three-pin connector of the present invention for the three-phase cable. Each sleeve-shaped body 2 would be fitted to its own bore in the bonnet. This arrangement could have space-saving advantages.

1. A connector assembly for facilitating an electrical connection through a pressure barrier, comprising:
a hollow body having first and second openings, intended when in use to be upper and lower respectively;
a conductor removably held in the body by a retaining means;
a first insulating layer insulating the conductor from the hollow body and forming a pressure barrier between the first and second openings;
a length of cable located in the second opening and having an insulated core, the core being connected to the conductor; and
a second insulating layer surrounding the connection of the conductor and the core and overlapping the insulating layer of the conductor and the insulation of the core, the second insulating layer being a number of wraps of dielectric tape or a dielectric heat-shrink.

2. A connector assembly according to claim 1, wherein the second insulating layer is a fluoropolymer.

3. A connector assembly according to claim 1, further including a chemical barrier layer, resistant to well fluids, around the second insulating layer.

4. A connector assembly according to claim 3, wherein the chemical barrier layer is a number of wraps of chemical barrier tape.

5. A connector assembly according to claim 1, further including a pressure bulkhead in the hollow body, through which the conductor passes.

6. A connector assembly according to claim 5, further including a packing material in the region of the cavity between the bulkhead and the second opening.

7. A connector assembly according to claim 5, wherein the packing material is a glass-fibre tape wrap or a potting compound, for instance an epoxy potting compound.

8. A connector assembly according to claim 1, wherein the conductor and core are crimped together.

9. A connector assembly according to claim 1, in combination with a wellhead having a tubing hanger penetrating the tubing hanger for supplying power to devices located down a well.

10. A method of forming an electrical connection through a pressure barrier in a hollow body, comprising the following steps:
attaching a conductor of a cable to a conductor having an insulating layer;
forming a second insulating layer over the joint of the cable conductor and the insulated conductor, the second insulating layer being formed by wrapping dielectric tape or applying a heat-shrink around the joint; and
inserting the insulated conductor into the hollow body, forming a seal.

11. A method according to claim 10, further including the step of forming a chemical barrier layer over the second insulating layer.

12. A method according to claim 11, wherein the chemical barrier layer is formed by wrapping chemical barrier tape around the insulating layer under tension.

13. A method according to claim 10, further including the step of wrapping glass-fibre tape over the previously formed layer or layers.

14. A method according to claim 10, further including the step of filling the cavity in the hollow body in which the joint is located with a potting compound.

15. A method according to claim 14, wherein the cavity is filled by injecting a potting compound through openings in the wall of the hollow body.

16. A method according to claim 10, further including the steps of:
inserting the conductor into a bulkhead with a portion of the conductor accessible from the lower side of the bulkhead, before attaching the conductor of the cable;
removing the conductor from the bulkhead after attaching the conductor of the cable; and
reinserting the conductor into the bulkhead and fixing it in place after forming the layer or layers.

17. A method according to claim 16, further including the steps of:
removing the bulkhead from the hollow body before inserting the conductor into the bulkhead; and
replacing the bulkhead in the hollow body after reinserting the conductor into the bulkhead.

18. A method according to claim 16, wherein the conductor is removed from and reinserted into the bulkhead from the lower side of the bulkhead.

19. A connector for facilitating an electrical connection through a pressure barrier, comprising:
a hollow body having first and second openings, intended when in use to be upper and lower respectively;
a bulkhead provided in the body; and
a conductor removably held in the bulkhead by a retaining means with a portion of the conductor extending from the bulkhead in the direction of the second opening;
the conductor having an insulating layer insulating the conductor from the bulkhead and extending along part of the said extending portion, forming a pressure barrier between the first and second openings.

20. A connector according to claim 19, wherein the insulating layer is polyetheretherketone (PEEK).

21. A connector according to claim 19, wherein the bulkhead is made of a non-ferromagnetic metal.

22. A connector according to claim 19, wherein the conductor is removable from the bulkhead in the direction of the second opening.

23. A connector according to claim 19, wherein the bulkhead is removably held in a sealed manner in the body, being seated on a shoulder within the body and held in place by a lock ring threaded to the hollow body.

24. A connector according claim 19, wherein the conductor is located in an axially extending opening in the bulkhead, the diameter of the axial opening being larger at the bottom of the bulkhead than at the top of the bulkhead, so that the opening tapers towards the top.

25. A connector according to claim 24, wherein there is a bulge in the cross-section of the insulating layer of the conductor that is of substantially the same diameter as the diameter of the opening at the bottom of the bulkhead, the top of the bulge engaging with the tapered part of the opening.

26. A connector according to claim 25, wherein the bottom of the bulge is tapered, preferably between 20° and 80°.

27. A connector according to claim 25, wherein a collar is located around the lower end of the bulge, the upper end of the collar engaging with the tapered part of the bulge.

28. A connector according to claim 19, wherein the retaining means is in the form of a plate secured to the underside of the bulkhead.

29. A connector according to claim 19, wherein there is an enlargement in the diameter of the conductor at the end of the portion extending below the bulkhead, with an axial recess for receiving a cable conductor.

30. A connector according to claim 29, wherein the outer diameter of the enlargement is substantially the same as the outer diameter of the insulating layer.

31. A connector according to claim 19, wherein a second portion of the conductor protrudes above the bulkhead in the direction beyond the first opening and the insulating layer covers a part of the second protruding conductor portion.

32. A connector according to claim 31, wherein a removable rubber boot is fitted over the said second protruding conductor portion.

33. A connector according to claim 19, wherein there is a radially extending opening in the body below the bulkhead for the injection of potting compound.

34. A connector according to claim 19, wherein there are a plurality of conductors in the bulkhead, preferably three conductors, in corresponding openings in the bulkhead.

35. A connector assembly including a connector according to any preceding claim and further comprising:
a length of cable located in the second opening having an insulated core, the core being connected to the conductor; and
a second insulating layer surrounding the connection of the conductor and the core and overlapping the insulating layer of the conductor and the insulation of the core.

36. A connector assembly according to claim 35, wherein the second insulating layer is a number of wraps of dielectric tape or a dielectric heat-shrink.

37. A connector according to claim 19, in combination with a wellhead (100) having a tubing hanger penetrating the tubing hanger for supplying power to devices located down a well.
